(19) United States
(12) Patent Application Publication
(10) Pub. No.: US 2025/0088017 A1
(43) Pub. Date: Mar. 13, 2025

(54) PORTABLE BATTERY CHARGING DEVICE

(71) Applicant: Sandy Laney, Van Nuys, CA (US)

(72) Inventor: Sandy Laney, Van Nuys, CA (US)

(21) Appl. No.: 18/243,232

(22) Filed: Sep. 7, 2023

(51) Int. Cl. H02J 7/00

(52) U.S. Cl. CPC H02J 7/0045; H02J 7/00047; H02J 7/0013; H02J 7/0063; H02J 2300/24

(57) ABSTRACT

A portable battery charging device includes a box and a plurality of solar panels each attached to the box to be exposed to sunlight. A plurality of first charging docks is each attached to the box to slidably engage a slide-on rechargeable battery. A plurality of second charging docks is each attached to the box to insertably receive a post of a rechargeable battery. A plurality of female electrical outlets is attached to the box to insertably receive a male plug of an electronic device. A plurality of charge ports is each recessed into the box to insertably receive a charge cord of an electronic device. A pair of third charging docks is each attached to the box to slidably engage a slide-on rechargeable battery.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to battery charging devices and more particularly pertains to a new battery charging device for charging a variety of rechargeable batteries in a remote location. The device includes a box and a plurality of solar panels attached to the box and a battery positioned within the box that is charged by the solar panels. The device includes a plurality of charging docks for charging a variety of different types of rechargeable batteries. The device includes charging ports recessed into the box for receiving charge cords of electronic devices and a plurality of female electrical outlets for receiving power cords of electronic devices.

### (2) Description of Related Art Including Information Disclosed Under 37 CFR 1.97 and 1.98

The prior art relates to battery charging devices including a variety of portable battery chargers that each includes solar panels that are electrically coupled to a plurality of charging docks for charging rechargeable batteries. In no instance does the prior art disclose a portable charging device that includes a variety of charging docks for charging rechargeable batteries and female electrical outlets for powering electronic devices and charge ports for receiving charge cords of electronic devices.

### BRIEF SUMMARY OF THE INVENTION

An embodiment of the disclosure meets the needs presented above by generally comprising a box and a plurality of solar panels each attached to the box to be exposed to sunlight. A plurality of first charging docks is each attached to the box to slidably engage a slide-on rechargeable battery. A plurality of second charging docks is each attached to the box to insertably receive a post of a rechargeable battery. A plurality of female electrical outlets is attached to the box to insertably receive a male plug of an electronic device. A plurality of charge ports is each recessed into the box to insertably receive a charge cord of an electronic device. A pair of third charging docks is each attached to the box to slidably engage a slide-on rechargeable battery.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a portable battery charging device according to an embodiment of the disclosure.

FIG. 2 is a bottom perspective view of an embodiment of the disclosure.

FIG. 3 is a front view of an embodiment of the disclosure.

FIG. 4 is a cross sectional view taken along line 4-4 of FIG. 3 of an embodiment of the disclosure.

FIG. 5 is a cross sectional view taken along line 5-5 of FIG. 3 of an embodiment of the disclosure.

FIG. 6 is a perspective in-use view of an embodiment of the disclosure.

### DETAILED DESCRIPTION OF THE INVENTION

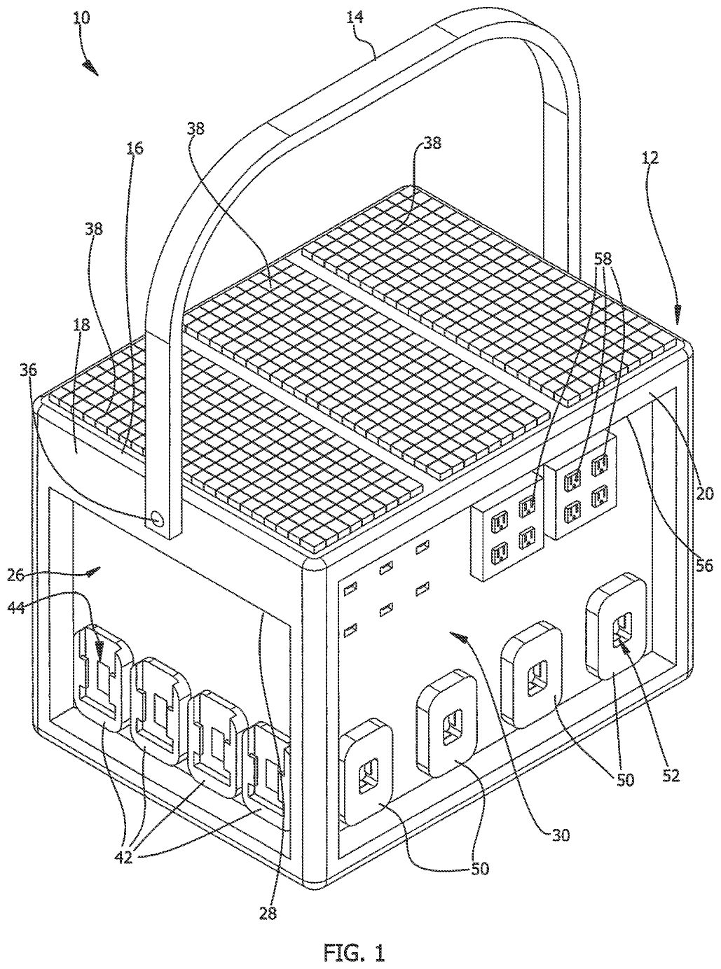

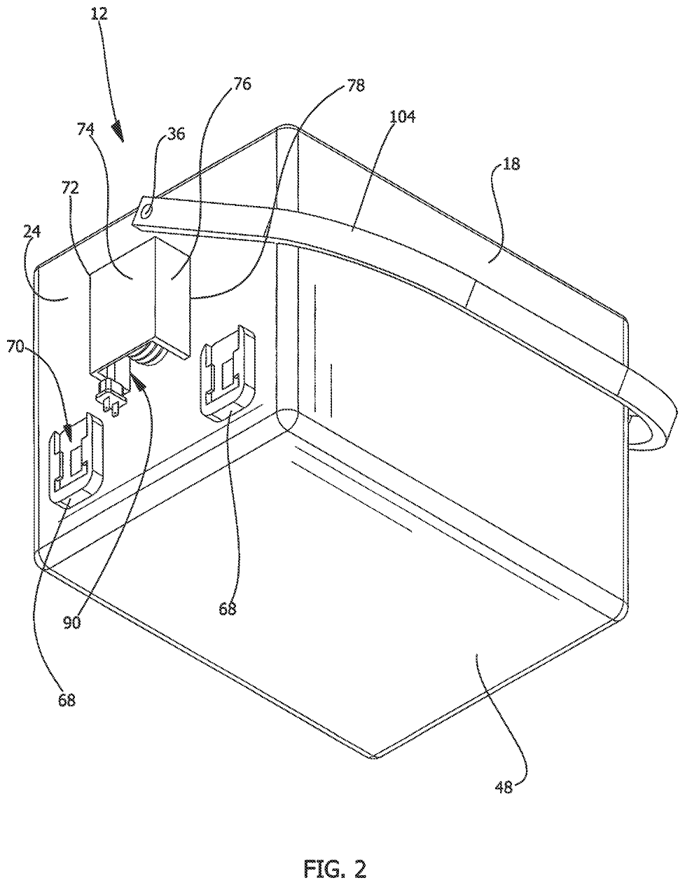

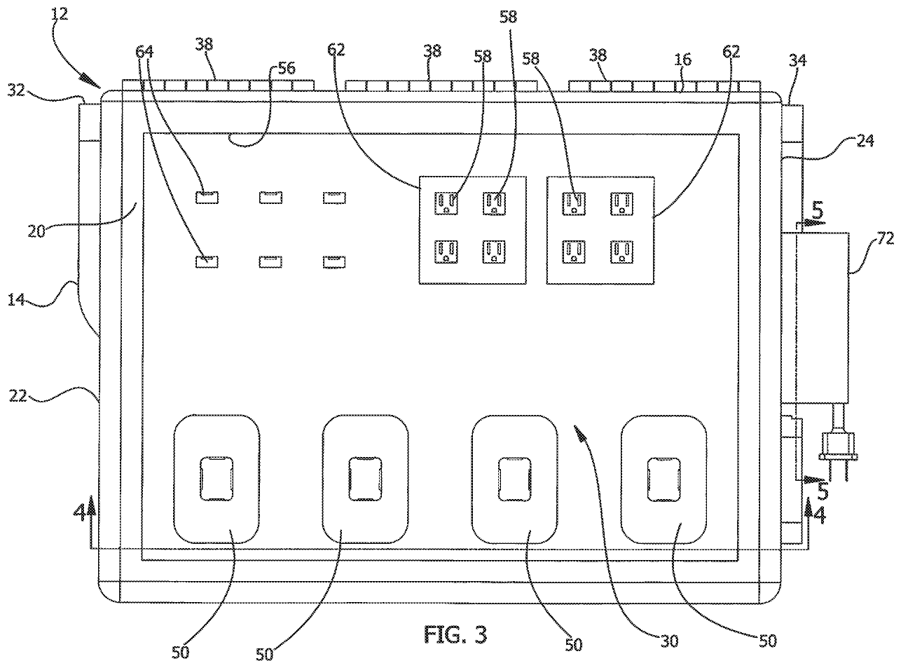

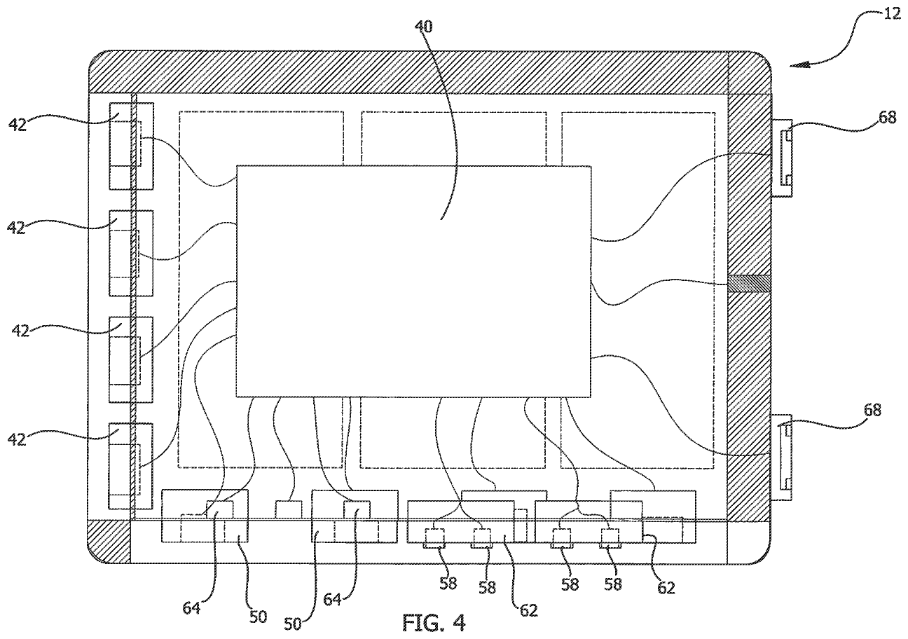

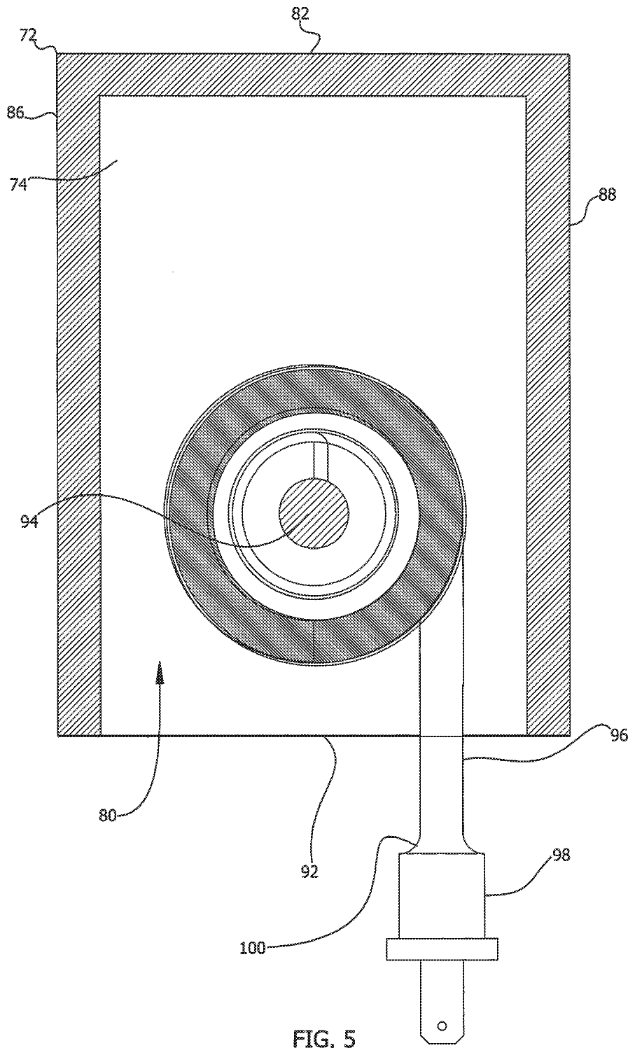

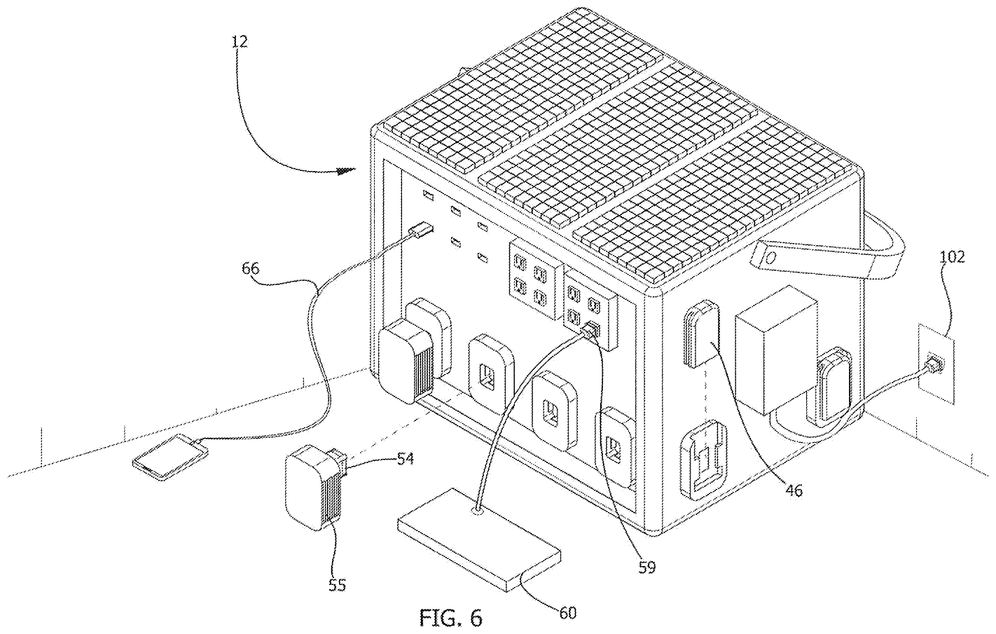

With reference now to the drawings, and in particular to FIGS. 1 through 6 thereof, a new battery charging device embodying the principles and concepts of an embodiment of the disclosure and generally designated by the reference numeral 10 will be described.

As best illustrated in FIGS. 1 through 6, the portable battery charging device 10 generally comprises a box 12 that has a handle 14 which is pivotally attached to the box 12 to facilitate the box 12 to be carried. The box 12 has a top wall 16 and an outer wall 18 extending downwardly from the top wall 16 and the outer wall 18 has a front side 20, a first lateral side 22 and a second lateral side 24. The outer wall 18 has a first recess 26 extending into the first lateral side 22 and the first recess 26 has an upper bounding surface 28 that is spaced downwardly from the top wall 16. Additionally, the outer wall 18 has a second recess 30 extending into the front side 20 and the handle 14 has a first end 32 and a second end 34.

The handle 14 has a pair of pivot points 36 each located adjacent a respective one of the first end 32 and the second end 34. The pivot point 36 associated with the first end 32 pivotally engages the first lateral side 22 of the outer wall 18 of the box 12 at a point positioned between the upper bounding surface 28 of the first recess 26 and the top wall 16. The pivot point 36 associated with the second end 34 pivotally engages the second lateral side 24 of the outer wall 18. The handle 14 is curved between the first end 32 and the second end 34 to facilitate the handle 14 to pass over the box 12 as the handle 14 is pivoted for gripping or for storage.

A plurality of solar panels 38 is each attached to the box 12 such that each of the plurality of solar panels 38 is exposed to sunlight. Each of the plurality of solar panels 38 is positioned on the top wall 16 of the box 12. The solar panels 38 are spaced apart from each other and are arranged in row extending between the first lateral side 22 and the second lateral side 24 of the outer wall 18 of the box 12. A battery 40 is positioned within the box 12 and the battery 40 is electrically coupled to the plurality of solar panels 38 such that the plurality of solar panels 38 charges the battery 40.

A plurality of first charging docks 42 is provided and each of the plurality of first charging docks 42 is attached to the box 12. Each of the plurality of first charging docks 42 has a channel 44 integrated into the first charging docks 42 to slidably engage a slide-on rechargeable battery 46. The slide-on rechargeable battery 46 may comprise a lithium ion rechargeable battery or the like which is commonly associated with cordless power tools. Each of the plurality of first charging docks 42 is in electrical communication with the plurality of solar panels 38 to charge a respective rechargeable battery 46.

Each of the plurality of first charging docks 42 is positioned in the first recess 26 on the first lateral side 22 of the outer wall 18 of the box 12. Additionally, the first charging docks 42 are spaced apart from each other and are laterally distributed across the first recess 26. Each of the plurality of first charging docks 42 is positioned closer to a bottom wall 48 of the box 12 than the upper bounding surface 28 of the first recess 26. Each of the plurality of first charging docks 42 is electrically coupled to the battery 40 in the box 12 to charge the rechargeable batteries 46 that are attached to the plurality of first charging docks 42.

A plurality of second charging docks 50 is provided and each of the plurality of second charging docks 50 is attached to the box 12. Each of the plurality of second charging docks 50 has a well 52 which extends into the second charging docks 50 to insertably receive a post 54 of a rechargeable battery 55. The rechargeable battery 55 that is charged in the second charging docks 50 may comprise a lithium ion rechargeable battery or the like which is commonly associated with cordless power tools. Each of the plurality of second charging docks 50 is in electrical communication with the plurality of solar panels 38 to charge a respective rechargeable battery 55. Each of the plurality of second charging docks 50 is positioned in the second recess 30. The second charging docks 50 are spaced apart from each other and are laterally distributed along the second recess 30. Additionally, each of the second charging docks 50 is positioned closer to the bottom wall 48 of the box 12 than an upper bounding surface 56 of the second recess 30. Each of the plurality of second charging docks 50 is electrically coupled to the battery 40 in the box 12.

A plurality of female electrical outlets 58 is each attached to the box 12 to insertably receive a male plug 59 of an electronic device 60. Each of the plurality of female electrical outlets 58 is in electrical communication with the plurality of solar panels 38 to power the electronic device 60. The electronic device 60 may comprise any electronic device that requires alternating current to function. Each of the plurality of female electrical outlets 58 is positioned in the second recess 30 and each of the plurality of female electrical outlets 58 is positioned between the plurality of second charging docks 50 and the upper bounding surface 56 of the second recess 30. Additionally, each of the plurality of female electrical outlets 58 is electrically coupled to the battery 40 in the box 12. Each of the plurality of female electrical outlets 58 is positioned on a respective one of a pair of converters 62 that are each mounted in the second recess 30 for converting direct current voltage of the battery 40 in the box 12 into alternating current voltage for the female electrical outlets 58.

A plurality of charge ports 64 is each recessed into the box 12 to insertably receive a charge cord of an electronic device 66. Each of the plurality of charge ports 64 is electrically coupled to the plurality of solar panels 38 to charge the electronic device 66. Each of the plurality of charge ports 64 is recessed into the front wall of the box 12 having each of the plurality of charge ports 64 being positioned in the second recess 30. Each of the plurality of charge ports 64 is positioned between the plurality of second charging docks 50 and the upper bounding surface 56 of the second recess 30. The plurality of charge ports 64 may comprise universal serial bus ports or other type of charge port commonly associated with charging personal electronic devices.

A pair of third charging docks 68 is provided and each of the pair of third charging docks 68 is attached to the box 12. Each of the pair of third charging docks 68 has a channel 70 integrated into the third charging docks 68 to slidably engage a slide-on rechargeable battery 46. Additionally, each of the pair of third charging docks 68 is in electrical communication with the pair of solar panels 38 to charge a respective rechargeable battery 40. Each of the third charging docks 68 is positioned on the second lateral side 24 of the outer wall 18 of the box 12 and each of the third charging docks 68 is positioned closer to the bottom wall 48 of the box 12 than the top wall 16 of the box 12. Furthermore, each of the third charging docks 68 is electrically coupled to the battery 40 in the box 12.

A cover 72 is provided that has a forward wall 74 and a perimeter wall 76 extending away from the forward wall 74. A distal edge 78 of the perimeter wall 76 is attached to the second lateral side 24 of the outer wall 18 of the box 12 to define a storage space 80 between the forward wall 74 and the outer wall 18. The perimeter wall 76 has an upper side 82, a first sidelong side 86 and a second sidelong side 88 such that an opening 90 is defined along a bottom edge 92 of the forward wall 74 which extends into the storage space 80. The cover 72 is centrally positioned between the pair of third charging docks 68 and the cover 72 is positioned between the top wall 16 of the box 12 and the pair of third charging docks 68.

A spool 94 is rotatably coupled to the outer wall 18 of the box 12 and the spool 94 is positioned in the storage space 80 defined in the cover 72. The spool 94 is biased to rotate in a first direction and the spool 94 is rotatable in a second direction. A power cord 96 is wrapped around the spool 94 and the power cord 96 is electrically coupled to the battery 40 in the box 12. A male plug 98 is electrically coupled to a free end 100 of the power cord 96. Furthermore, the power cord 96 is drawable outwardly through the opening 90 in the cover 72 thereby facilitating the male plug 98 to be plugged into a power source 102 comprising a female electrical outlet for charging the battery 40 in the box 12.

In use, the power cord 96 is plugged into the power source 102 to charge the battery 40 in the box 12 prior to charging any of the rechargeable batteries 46, 55. The slide-on rechargeable batteries 46 are attachable to any of the first charging docks 42 or the third charging docks 68 and the rechargeable batteries 55 with a post 54 are attachable to any of the second charging docks 50. In this way a large number of rechargeable batteries 46, 55 can simultaneously be recharged. The male plug 59 of the electronic devices 60 can be plugged into any of the female electrical outlets 58 and the charge cord for the electronic device 66 can be plugged into any of the charge ports 64. Furthermore, the plurality of solar panels 38 continuously charges the battery 40 in the box 12 to extend the charging capacity of the battery 40 in the box 12. The power cord 96 can remain plugged into the power source 102, if available, while the rechargeable batteries 46, 55 and electronic devices 60, 66 are being charged.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable battery charging device for charging a plurality of batteries in a remote location, said device comprising:
a box having a handle being pivotally attached to said box to facilitate said box to be carried;
a plurality of solar panels, each of said plurality of solar panels being attached to said box wherein each of said plurality of solar panels is configured to be exposed to sunlight;
a plurality of first charging docks, each of said plurality of first charging docks being attached to said box, each of said plurality of first charging docks having a channel integrated into said first charging docks wherein each of said first charging docks is configured to slidably engage a slide-on rechargeable battery, each of said plurality of first charging docks being in electrical communication with said plurality of solar panels wherein each of said plurality of first charging docks is configured to charge a respective rechargeable battery;
a plurality of second charging docks, each of said plurality of second charging docks being attached to said box, each of said plurality of second charging docks having a well extending into said second charging docks wherein said well in each of said second charging docks is configured to insertably receive a post of a rechargeable battery, each of said plurality of second charging docks being in electrical communication with said plurality of solar panels wherein each of said plurality of second charging docks is configured to charge a respective rechargeable battery;
a plurality of female electrical outlets, each of said plurality of female electrical outlets being attached to said box wherein each of said plurality of female electrical outlets is configured to insertably receive a male plug of an electronic device, each of said plurality of female electrical outlets being in electrical communication with said plurality of solar panels wherein said plurality of female electrical outlets is configured to power the electronic device;
a plurality of charge ports, each of said plurality of charge ports being recessed into said box wherein each of said plurality of charge ports is configured to insertably receive a charge cord of an electronic device, each of said plurality of charge ports being electrically coupled to said plurality of solar panels wherein each of said plurality of charge ports is configured to charge the electronic device; and
a pair of third charging docks, each of said pair of third charging docks being attached to said box, each of said pair of third charging docks having a channel integrated into said third charging docks wherein each of said third charging docks is configured to slidably engage a slide-on rechargeable battery, each of said pair of third charging docks being in electrical communication with said pair of solar panels wherein each of said pair of third charging docks is configured to charge a respective rechargeable battery.

2. The device according to claim 1, wherein:
said box has a top wall and an outer wall extending downwardly from said top wall, said outer wall having a front side, a first lateral side and a second lateral side;
said outer wall has a first recess extending into said first lateral side, said first recess having an upper bounding surface being spaced downwardly from said top wall;
said outer wall has a second recess extending into said front side;
said handle having a first end and a second end, said handle having a pair of pivot points each being located adjacent a respective one of said first end and said second end;
said pivot point associated with said first end pivotally engages said first lateral side of said outer wall of said box at a point positioned between said upper bounding surface of said first recess and said top wall;
said pivot point associated with said second end pivotally engages said second lateral side of said outer wall; and
each of said plurality of solar panels is positioned on said top wall of said box, said plurality of solar panels being spaced apart from each other and being arranged in row extending between said first lateral side and said second lateral side of said outer wall of said box.

3. The device according to claim 2, wherein:
said device includes a battery being positioned within said box, said battery being electrically coupled to said plurality of solar panels such that said plurality of solar panels charges said battery;
each of said plurality of first charging docks is positioned in said first recess on said first lateral side of said outer wall of said box;
said plurality of charging docks is spaced apart from each other and laterally distributed across said first recess;
each of said plurality of first charging docks is positioned closer to a bottom wall of said box than said upper bounding surface of said first recess; and
each of said plurality of first charging docks is electrically coupled to said battery in said box wherein said battery in said box is configured to charge the rechargeable batteries that are attached to said plurality of first charging docks.

4. The device according to claim 2, wherein:
said device includes a battery being positioned within said box, said battery being electrically coupled to said plurality of solar panels such that said plurality of solar panels charges said battery;
each of said plurality of second charging docks is positioned in said second recess;
said plurality of second charging docks is spaced apart from each other and laterally distributed along said second recess;
each of said second charging docks is positioned closer to said bottom wall of said box than an upper bounding surface of said second recess; and
each of said plurality of second charging docks is electrically coupled to said battery in said box.

5. The device according to claim 2, wherein:
said device includes a battery being positioned within said box, said battery being electrically coupled to said plurality of solar panels such that said plurality of solar panels charges said battery;
each of said plurality of female electrical outlets is positioned in said second recess;
each of said plurality of female electrical outlets being positioned between said plurality of second charging docks and said upper bounding surface of said second recess; and
each of said plurality of female electrical outlets being electrically coupled to said battery in said box.

6. The device according to claim 2, wherein each of said plurality of charge ports is recessed into said front wall of said box having each of said plurality of charge ports being positioned in said second recess, each of said plurality of charge ports being positioned between said plurality of second charging docks and said upper bounding surface of said second recess.

7. The device according to claim 2, wherein each of said third charging docks is positioned on said second lateral side of said outer wall of said box, each of said third charging docks being positioned closer to said bottom wall of said box than said top wall of said box, each of said third charging docks being electrically coupled to said battery in said box.

8. The device according to claim 2, further comprising a cover having a forward wall and a perimeter wall extending away from said forward wall, a distal edge of said perimeter wall being attached to said second lateral side of said outer wall of said box to define a storage space between said forward wall and said outer wall, said perimeter wall having an upper side and a first sidelong side and a second sidelong side such that an opening is defined along a bottom edge of said forward wall which extends into said storage space, said cover being centrally positioned between said pair of third charging docks, said cover being positioned between said top wall of said box and said pair of third charging docks.

9. The device according to claim 8, further comprising a spool being rotatably coupled to said outer wall of said box, said spool being positioned in said storage spaced defined in said cover, said spool being biased to rotate in a first direction, said spool being rotatable in a second direction.

10. The device according to claim 9, further comprising:
a battery being positioned within said box, said battery being electrically coupled to said plurality of solar panels such that said plurality of solar panels charges said battery; and
a power cord being wrapped around said spool, said power cord being electrically coupled to said battery in said box, said power cord having a male plug being electrically coupled to a free end of said power cord, said power cord being drawable outwardly through said opening in said cover thereby facilitating said male plug to be plugged into a power source comprising a female electrical outlet for charging said battery in said box.

11. A portable battery charging device for charging a plurality of batteries in a remote location, said device comprising:
a box having a handle being pivotally attached to said box to facilitate said box to be carried, said box having a top wall and an outer wall extending downwardly from said top wall, said outer wall having a front side, a first lateral side and a second lateral side, said outer wall having a first recess extending into said first lateral side, said first recess having an upper bounding surface being spaced downwardly from said top wall, said outer wall having a second recess extending into said front side, said handle having a first end and a second end, said handle having a pair of pivot points each being located adjacent a respective one of said first end and said second end, said pivot point associated with said first end pivotally engaging said first lateral side of said outer wall of said box at a point positioned between said upper bounding surface of said first recess and said top wall, said pivot point associated with said second end pivotally engaging said second lateral side of said outer wall;
a plurality of solar panels, each of said plurality of solar panels being attached to said box wherein each of said plurality of solar panels is configured to be exposed to sunlight, each of said plurality of solar panels being positioned on said top wall of said box, said plurality of solar panels being spaced apart from each other and being arranged in row extending between said first lateral side and said second lateral side of said outer wall of said box;
a battery being positioned within said box, said battery being electrically coupled to said plurality of solar panels such that said plurality of solar panels charges said battery;
a plurality of first charging docks, each of said plurality of first charging docks being attached to said box, each of said plurality of first charging docks having a channel integrated into said first charging docks wherein each of said first charging docks is configured to slidably engage a slide-on rechargeable battery, each of said plurality of first charging docks being in electrical communication with said plurality of solar panels wherein each of said plurality of first charging docks is configured to charge a respective rechargeable battery, each of said plurality of first charging docks being positioned in said first recess on said first lateral side of said outer wall of said box, said plurality of charging docks being spaced apart from each other and being laterally distributed across said first recess, each of said plurality of first charging docks being positioned closer to a bottom wall of said box than said upper bounding surface of said first recess, each of said plurality of first charging docks being electrically coupled to said battery in said box wherein said battery in said box is configured to charge the rechargeable batteries that are attached to said plurality of first charging docks;
a plurality of second charging docks, each of said plurality of second charging docks being attached to said box, each of said plurality of second charging docks having a well extending into said second charging docks wherein said well in each of said second charging docks is configured to insertably receive a post of a rechargeable battery, each of said plurality of second charging docks being in electrical communication with said plurality of solar panels wherein each of said plurality of second charging docks is configured to charge a respective rechargeable battery, each of said plurality of second charging docks being positioned in said second recess, said plurality of second charging docks being spaced apart from each other and being laterally distributed along said second recess, each of said second charging docks being positioned closer to said bottom wall of said box than an upper bounding surface of said second recess, each of said plurality of second charging docks being electrically coupled to said battery in said box;
a plurality of female electrical outlets, each of said plurality of female electrical outlets being attached to said box wherein each of said plurality of female electrical outlets is configured to insertably receive a male plug of an electronic device, each of said plurality of female electrical outlets being in electrical communication with said plurality of solar panels wherein said plurality of female electrical outlets is configured to power the electronic device, each of said plurality of female electrical outlets being positioned in said second recess, each of said plurality of female electrical outlets being positioned between said plurality of second charging docks and said upper bounding surface of said second recess, each of said plurality of female electrical outlets being electrically coupled to said battery in said box;
a plurality of charge ports, each of said plurality of charge ports being recessed into said box wherein each of said plurality of charge ports is configured to insertably receive a charge cord of an electronic device, each of said plurality of charge ports being electrically coupled to said plurality of solar panels wherein each of said plurality of charge ports is configured to charge the electronic device, each of said plurality of charge ports being recessed into said front wall of said box having each of said plurality of charge ports being positioned in said second recess, each of said plurality of charge ports being positioned between said plurality of second charging docks and said upper bounding surface of said second recess;
a pair of third charging docks, each of said pair of third charging docks being attached to said box, each of said pair of third charging docks having a channel integrated into said third charging docks wherein each of said third charging docks is configured to slidably engage a slide-on rechargeable battery, each of said pair of third charging docks being in electrical communication with said pair of solar panels wherein each of said pair of third charging docks is configured to charge a respective rechargeable battery, each of said third charging docks being positioned on said second lateral side of said outer wall of said box, each of said third charging docks being positioned closer to said bottom wall of said box than said top wall of said box, each of said third charging docks being electrically coupled to said battery in said box;
a cover having a forward wall and a perimeter wall extending away from said forward wall, a distal edge of said perimeter wall being attached to said second lateral side of said outer wall of said box to define a storage space between said forward wall and said outer wall, said perimeter wall having an upper side and a first sidelong side and a second sidelong side such that an opening is defined along a bottom edge of said forward wall which extends into said storage space, said cover being centrally positioned between said pair of third charging docks, said cover being positioned between said top wall of said box and said pair of third charging docks;
a spool being rotatably coupled to said outer wall of said box, said spool being positioned in said storage spaced defined in said cover, said spool being biased to rotate in a first direction, said spool being rotatable in a second direction; and
a power cord being wrapped around said spool, said power cord being electrically coupled to said battery in said box, said power cord having a male plug being electrically coupled to a free end of said power cord, said power cord being drawable outwardly through said opening in said cover thereby facilitating said male plug to be plugged into a power source comprising a female electrical outlet for charging said battery in said box.
